(19) United States
(12) Patent Application Publication
(10) Pub. No.: US 2023/0040949 A1
(43) Pub. Date: Feb. 9, 2023

(54) MASSAGE METHOD AND DEVICE FOR CARRYING OUT SAME

(71) Applicant: Tatiana Alekseevna SHYMCHYSHYNA, Dnepr (UA)

(72) Inventor: Tatiana Alekseevna SHYMCHYSHYNA, Dnepr (UA)

(21) Appl. No.: 17/794,060

(22) PCT Filed: Jan. 14, 2021
(86) PCT No.: PCT/UA2021/000001

§ 371 Date: Jul. 20, 2022

(30) Foreign Application Priority Data
Jan. 21, 2020 (UA) A 2020 00329

(51) Int. Cl. A61H 23/04; A61H 9/00

(52) U.S. Cl. CPC A61H 23/04; A61H 9/0007; A61H 2201/1654; A61H 2201/0153

(57) ABSTRACT

A massage method includes acting on localized portions of a patient's body using streams of a pressurized fluid medium is characterized in that the streams of the fluid medium are formed as pulsating streams by a contoured surface with continuous channels and act on a chosen localized portion of the patient's body until resonant vibration occurs within the range of audio frequencies that are characteristic for that portion. A device for carrying out a massage according to the claimed method comprises a fluid medium generator connected to massage heads. In the claimed massage method and device for carrying out same, the introduction of novel structural elements and parameters results in a different action on localized portions of the patient, while simplifying adjustment of the parameters of said action and increasing the range of localized portions that can be acted on.

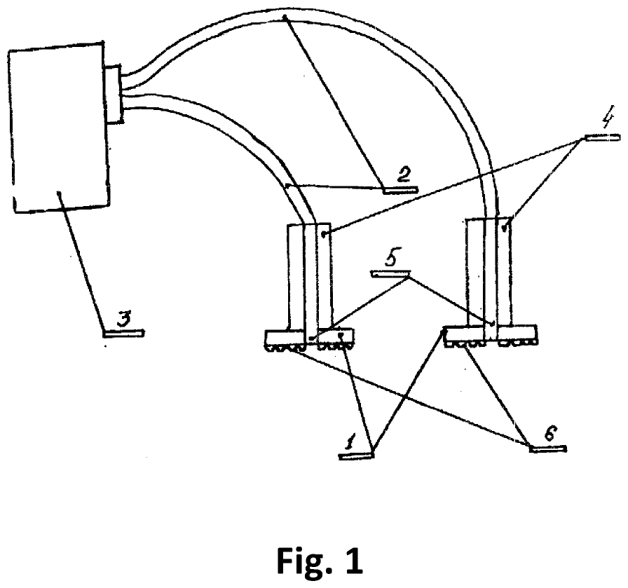

### CROSS-REFERENCE TO RELATED APPLICATIONS

The present application is a national phase application of PCT Application No. PCT/UA2021/000001, filed Jan. 14, 2021, entitled “MASSAGE METHOD AND DEVICE FOR CARRYING OUT SAME”, which claims the benefit of Ukrainian Patent Application No. A2020 00329, filed Jan. 21, 2020, each of which is incorporated by reference in its entirety.

### BACKGROUND OF THE INVENTION

### 1. Field of the Invention

The invention relates to the sports, medicine and cosmetics industry for sports, prophylactic, recreational, and cosmetic massages.

### 2. Description of the Related Art

A “massage method and device for its implementation” is known from UA72857A.

The essence of the method is the combination of two different physical factors: direct vacuum and imitation electro pulse. In the method of vacuum massage effect, which consists of manual diagnostics, depression massage and depression drainage, a reflex effect with pulsed electric current is performed simultaneously with the vacuum massage and, after manual diagnostics, the energetic activity of the organs is balanced according to the meridional channels corresponding to the diagnosis.

The disadvantage of the method used by the device is the complexity of the massage, which excludes the possibility of massaging certain parts of the body. The massage uses vacuum jets that stretch the skin.

The next known technical solution is the “Method of Massage” of RU94023167 A. Massage is performed by non-contact action of the operator's hand, radiating energy to a specific part of the patient's body. An air jet is applied in addition to the pressure area. The beam is aimed at the patient's body from different angles and from different distances.

Disadvantages of this method are that the use is complicated by requiring the mandatory presence of an operator and that it does not allow a self-massage using the massage device. Features of the massage procedure limit the range of selection of local zones of influence and regulation by exposure parameters.

In addition, a massage device is known from UA66441 A1, which includes a shaft of rods on which massage rollers and springs in the form of S-shaped plates are installed. The device is placed on the massaged area of the body, with the handles pressed lightly against the body and massaging it in a back and forth motion in a direction perpendicular to the shaft. The rollers pressed into the body move and cause forced movement of the skin and blood in the direction of movement and knead the muscles and perform a body massage.

The disadvantage of this device is that the massager provides a mechanical effect, which excludes the possibility of massage on some parts of the body and does not take into account the characteristics of the patient's tissues.

The next device known from WO2009094144 A2 is a “hydrotherapeutic massage device”. Disclosed is a method and apparatus for hydrotherapeutic stimulation including a device having a handle and an external engagement surface for contacting the user's lower body. An air-water flow generator connected to a water inlet and the air inlet located in the housing and the pump means transmit the pressure rise and water flow inside the housing to the outlet nozzle. A power source is electrically connected to the pump assembly within the housing. The air-water outlet nozzle is located at the front of the body and is connected to the air-water flow generator to transmit the air-water flow to the user's lower body, which is in front of the outlet nozzle.

The disadvantage of the device is the complexity of the design. For massage, a nozzle is used that creates a pressure effect without taking into account the individual characteristics of the patient's tissues, which, moreover, is intended for limited local areas and does not provide security and a sufficient opportunity to control the massage parameters.

### SUMMARY OF THE INVENTION

The object of the invention is to improve known massage methods by achieving a different effect on the patient's local zones by introducing new technological parameters, with the possibility of simplifying the regulation by expanding local zones of influence, including self-regulation of the influencing parameters due to the degree of activation of the zones and the resulting increased efficiency and safety of the massage, so that self-massage with the massager is possible.

The problem is solved in that, based on a known device for massage, which contains a generator for moving a medium, a device according to the invention is proposed, in which the generator is movably connected to the massage nozzles, wherein the surface of the massage nozzles has continuous channels to form a pulsating flow of the moving medium.

### BRIEF DESCRIPTION OF THE DRAWINGS

The FIGURE shows a device for performing a massage according to the claimed method, wherein massage nozzles 1 with a relief surface 6 and passage channels 5 and holders 4 in the form of handles are movably connected to a generator 3 for a moving medium using flexible hoses 2.

### DETAILED DESCRIPTION

The invention is carried out as follows: a local massage area is selected, a massage nozzle 1 with a relief surface 6 is brought in contact to the patient's body. The generator 3 for providing the flow of the moving medium in the form of an air, water, or air-water flow under pressure is switched on so that the moving medium under pressure flows through the flexible hoses 2, then along the holders 4 of the massage nozzles 1 and through the passage channels 5 of the massage nozzles 1 and then between the relief surface 6 of the massage nozzle 1 and the patient's body. The relief surface 6 of the massage head 1 with continuous channels 5 enables the formation of a continuous or discretely adjustable pulsating flow of the pressurized moving medium when the stream of the moving medium under pressure is supplied. It is the pulsating flow of the moving medium that produces resonant vibrations in the spectrum of sound frequencies in the patient's tissues, which are characteristic for that area of the patient. The moment of appearance of sound frequencies indicates a sufficient level of activation of the selected local zone. The vibrations enable the patient's superficial and deep layers of the body, including damaged layers of the body, to be activated sufficiently evenly. At the same time, it is possible to determine and select parameters individually for each patient and for different local zones on the patient's body, by using nozzles 1 with different types of relief surfaces 6, thereby it is possible to change the intensity and pace of the flow of the medium provided by the generator 3. During a test, the results were evaluated based on the person's sensation and well-being. Very often pain syndrome disappears after the first massage. By adjusting the flow rate of the moving medium, the massage has a stimulating or relaxing effect on the patient. The resonance effect has a long-lasting effect. After the massage, the patient feels a vibration in the muscles and the so-called “muscle joy” for a long time.

Resonant vibrations speed up the metabolism in the patient's tissues, enabling the elimination of stagnation in the body and the discomfort caused by this stagnation. At the same time, it is worth noting the simplicity of the massage, so it is accessible and easy for the patient to perform self-massage in any selected area of the body.

Massages with the proposed massage device according to the claimed method can be used for:
Performing a cosmetic massage, that effectively tightens the skin of the face, relieves puffiness, improves the complexion;
Carrying out a preventive massage for various diseases due to the fact that the resonant vibrations occurring in the patient's tissues make it possible to eliminate congestion in the human body, improve metabolism, remove excess fluid due to lymphatic drainage and to enhance the tone of muscles and blood vessels;
Carrying out a rehabilitation massage after operations of fractures;
Carrying out sports massages to minimize overexertion and overwork after exercise;
Posture correction massage;
Carrying out a massage in a whirlpool, in a bathroom, in a pool, in a bath;
Conducting self-massage and “hardware-only” massage at home and in massage parlors.

1-2. (canceled)

3. A method of massage, comprising:
forming pulsating flows of a medium moving under pressure by a relief surface comprising continuous channels; and
directing the pulsating flows of the medium to act on a selected local area of a patient until resonant vibrations occur in a range of sound frequencies characteristic of the selected local area.

4. The method as claimed in claim 3, further comprising:
bringing a massage nozzle in contact with a patient's body, the massage nozzle comprising the relief surface and a central passage channel and said massage nozzle connected to a generator for moving the medium under pressure;
wherein the medium flows through the central passage channel of the massage nozzle and then flows between the relief surface of the massage nozzle and the patient's body with the continuous channels forming the pulsating flows.

5. The method as claimed in claim 4, wherein a flow rate of the medium is adjustable.

6. The method as claimed in claim 4, wherein nozzles with different types of relief surfaces are used for different local zones on the patient's body.

7. A massage device comprising:
a generator for moving a medium connected to massage nozzles;
wherein a surface of the massage nozzles is provided with continuous channels to form a pulsating flow of the medium.

8. The massage device as claimed in claim 7, wherein the generator and the massage nozzles are connected by flexible hoses.

9. The massage device as claimed in claim 7, wherein each massage nozzle comprises one central passage channel for the medium.

10. The massage device as claimed in claim 9, wherein each massage nozzle comprises a relief surface located around the central passage channel and comprises said continuous channels.
